(19) United States
(12) Patent Application Publication
(10) Pub. No.: US 2008/0245994 A1
(43) Pub. Date: Oct. 9, 2008

(54) Cleaning Method

(75) Inventor: Roberto Casonati, Mira (IT)

Correspondence Address: NORRIS, MCLAUGHLIN & MARCUS, 875 THIRD AVE, 18TH FLOOR, NEW YORK, NY, 10022, US

(73) Assignee: RECKITT BENCKISER N.V., Hoofddorp (NL)

(21) Appl. No.: 10/597,354

(22) PCT Filed: Jan. 7, 2005
(86) PCT No.: PCT/GB2005/000030

§ 371 Date: Aug. 14, 2006

(30) Foreign Application Priority Data
Jan. 31, 2004 (GB) 0402165.5

(51) Int. Cl. C02F 5/10

(52) U.S. Cl. 252/180

(57) ABSTRACT

This invention relates to a method of softening water and/or in which the deposition of hard water scale is inhibited. The invention relates in particular to such a method carried out in a domestic environment, in particular in ware-washing machines. A compressed water-softening composition comprising a water softening active and a blend of disintegrating agents, comprising a cross-linked polyplasdone, a water-swellable cellulose and optionally a water soluble salt is claimed.

This invention relates to a method of softening water and/or in which the deposition of hard water scale is inhibited. The invention relates in particular to such a method carried out in a domestic environment, in particular in ware-washing machines. The invention also relates to compressed water-softening compositions for such methods.

It is well known that certain metal compounds, notably calcium compounds, when present in water, have a significant effect on the properties of the water. For example, “hard” water containing a significant loading of soluble calcium and magnesium compounds may require a large amount of soap or detergent in order to form a lather. Scale deposits can readily form from such water, for example on heating or pH change or evaporation. These can be encrustations, or watermarks left on evaporation of water droplets from, especially, a shiny surface.

There have been many proposals for removal of metal ions from aqueous solutions. In the industrial context proposals have included filter beds and polymeric filters for capturing heavy metal ions from an aqueous solution flowing within a passageway. Examples are given in EP992238A and GB20869564A. In the domestic context chelating compositions can be added to an aqueous washing solution and these can capture metal ions, such as calcium ions. Examples of chelating compositions are given in EP892040A.

Increasingly popular is the delivery of cleaning and water-softening compositions as compressed compositions, typically a tablet. These are convenient, providing a unit dosage which is easily handled. Difficulties arise in the production of such compressed compositions in balancing the needs that the compressed composition is suitably hard and non-friable under transportation conditions but yet is not so compacted that it cannot easily disintegrate. Suitable levels of “hardness” are between 150 N and 250 N (the test conditions being set out in the Example section). Suitable levels of “friability” are between 2% and 9% (the test conditions being set out in the Example section). Suitable “disintegration” times are between 5 seconds and 180 seconds, when placed in 11 of gently stirred water at 25° C.

It is well known in the art to include a disintegrant, which will promote disintegration of the tablet in laundry detergent tablets and laundry detergent additive tablets. Various classes of disintegrants are known, including the class in which disintegration is caused by the swelling of the disintegrant. Various swelling disintegrants have been proposed in the literature, for instance in WO 98/54283, with the preference being directed predominantly towards starches, celluloses and water soluble organic polymers. Furthermore, inorganic swelling disintegrants such as bentonite clay have also been mentioned, for instance in EP-A-0466 484.

We have found that water-softening compositions are particularly difficult compositions to compress and retain as a compressed solid. This is mainly due to the high content of crystalline solids (as compared to detergent tablets that contain higher amounts of organic molecules, such as surfactant), for example, citrate salts and silicates, that do not easily bind together. Therefore, much higher compression forces are needed to produce suitable compressed compositions. Compression forces used are greater than 35 KN, 40 KN, 45 KN or 50 KN. However, compression forces are usually less than 100 KU, 95 KN, 90 KN, or 85 KN.

We have found a particularly suitable water softening composition for the formation of a compressed composition that provides high levels of hardness of at least 100 N, 150 N, 175 N or 200 N. Hardness levels are usually less than 300 N, 275 N or 250 N. An acceptably low lend of friability of less than 15%, 10% or 8%. Low disintegration times of less than 1 minute are achieved ideally between 20 and 30 seconds.

EP 0812808 discloses water-softening tablets containing disintegrants.

Therefore, we present as a first feature of the invention a compressed water softening composition comprising at least one water-softening active and a blend of disintegrating agents comprising
(a) cross linked polyplasdone;
(b) a water-swellable cellulose; and, optionally,
(c) a water-soluble salt.

By the use of the term water-softening composition we mean that the composition is substantially free of surfactant and/or bleach ingredients, i.e. less than 5% or 1% by weight, ideally 0% by weight.

As discussed above, water softening compositions are characterised in that they contain large amounts of water softening active ingredients that are crystalline material, i.e. more than 35% by weight, more than 38% by weight, more than 40% by weight or more than 42% by weight.

Typical crystalline materials include citrate sales, zeolites, silicates and clays. Preferably such crystalline materials are selected from citrate salts or silicate.

The blend of disintegrating agents is present in an amount of up to 10%, 8%, 7%, 6%, 5%, 3% or 2% wt of the composition. The blend of disintegrating agents is present in an amount of at least 0.1%, 0.3%, 0.5%, 0.7%, 0.9%, 1.1%, 1.3%, 1.5% or 1.7% wt of the composition.

### Water Softening Active

Water-softening actives are present in the composition in an amount of at least 40%, 50%, 55%, 60%, 65%, 70%, 75%, 80%, 85% or 90% by weight of the composition. Maximum amounts of water-softening actives are present in an amount of less than 99%, 97%, 93%, 90%, 87%, 83% or 80% by weight of the composition.

There are three main types of method of action for water softening actives, described below.

1) Ion exchange agents—such agents include alkali metal (preferably sodium) aluminosilicates either crystalline, amorphous or a mixture of the two. Such aluminosilicates generally have a calcium ion exchange capacity of at least 50 mg CaO per gram of aluminosilicate, comply with a general formula:

0.8-1.5 Na₂O.Al₂O₃.0.8-6 SiO₂

and incorporate some water. Preferred sodium aluminosilicates within the above formula contain 1.5-3.0 SiO₂ units. Both amorphous and crystalline aluminosilicates can be prepared by reaction between sodium silicate and sodium aluminate, as amply described in the literature.

Suitable crystalline sodium aluminosilicate ion-exchange detergency builders are described, for example, in GB 1429143 (Procter & Gamble). The preferred sodium aluminosilicates of this type are the well known commercially available zeolites A and X, and mixtures thereof. Also of interest is zeolite P described in EP 384070 (Unilever).

Another class of compounds are the layered sodium silicate builders, such as are disclosed in US-A-4464839 and US-A-4820439 and also referred to in EP-A-551375.

These materials are defined in US-A-4820439 as being crystalline layered, sodium silicate of the general formula

NaMSiₓO₂ₓ₊.YH₂O

where

M denotes sodium or hydrogen,

x is from 1.9 to 4 and y is from 0 to 20.

Quoted literature references describing the preparation of such materials include Glastechn. Ber. 37,194-200 (1964), Zeitschrift fur Kristallogr. 129, 396-404 (1969), Bull. Soc. Franc. Min. Crist., 95, 371-382 (1972) and Amer. Mineral, 62, 763-771 (1977). These materials also function to remove calcium and magnesium ions from water, also covered are salts of zinc which have also been shown to be effective water softening agents.

2) Ion capture agents—agents which prevent metal ions from forming insoluble salts or reacting with surfactants, such as polyphosphate, monomeric polycarbonates, such as citric acid or salts thereof, EDTA, algins, alginates.

3) Anti-nucleating agents—agents which prevent seed crystal growth, such as polycarbonate polymers, such as polyacrylates, acrylic/maleic copolymers, and acrylic phosphonates, and sulfonates.

### Water-Soluble Salt

The water-soluble salt is an optional, but preferred, constituent of the disintegrant blend. Ideally it is present in amounts of up to 0.1% possibly up to 0.2, 0.4, 0.6, 0.8. 1.0, 1.2 or 1.4% by weight of the composition. Ideally the water-soluble salt is provided as at least 5%, 10%, 15%, 20%, 25%, 30%, 35%, 40%, 45%, 50%, 55%, 60%, 65%, 70%, 75%, 80% or 85% by weight of the disintegrant blend. Ideally the water-soluble salt is provided as no more than 95%, 90%, 85%, 80%, 75%, 70%, 65%, 60%, 55%, 50%, 45%, 40%, 35%, 30%, 25%, 20%, 15% or 10% by weight of the disintegrant blend.

Ideally the water-soluble salt has a solubility of at least 50 g/100 g in deionized water at 20° C. This is an exceptionally high solubility: many materials which are classified as water-soluble are less soluble. Suitable highly water-soluble materials which may be used are selected from, with their solubilities expressed as grams of solid to form a saturated solution in 100 g of deionized water at 20°C.: potassium acetate >200, potassium carbonate 112, urea >100, sodium acetate anhydrous 119, sodium acetate trihydrate 76 and magnesium sulphate. 7H2O 71 or mixtures thereof.

The rapid dissolution of the water-soluble salt provides rapid ingress of water into the tablet, thus not only affecting the tablet's integrity, but allowing water to rapidly access the other disintegrant components within the tablet, particularly the swelling disintegrants.

By contrast the solubilities of some other common materials at 20° C. are: sodium chloride 36, sodium sulphate decahydrate 21.5, sodium carbonate anhydrous 6.0, sodium percarbonate anhydrous 12, sodium perborate anhydrous. Preferably this highly water soluble material is incorporated as particles of the material in a substantially pure form (i.e. each such particle contains over 95% by weight of the material).

### Cross Linked Polyplasdone

Ideally present in the composition in amounts of up to 0.1% possibly up to 0.2, 0.4, 0.6, 0.8. 1.0, 1.2 or 1.4% by weight of the composition. Ideally the cross linked polyplasdone is provided as at least 5%, 10%, 15%, 20%, 25%, 30%, 35%, 40%, 45%, 50%, 55%, 60%, 65%, 70%, 75%, 80% or 85% by weight of the disintegrant blend. Ideally the cross linked polyplasdone is provided as no more than 95%, 90%, 85%, 80%, 75%, 70%, 65%, 60%, 55%, 50%, 45%, 40%, 35%, 30%, 25%, 20%, 15% or 10% by weight of the disintegrant blend.

Cross linked polyplasdone consists of N-vinyl-2-pyrrolidone polymerised and cross-linked simultaneously by a reaction known as “pop-corn” polymerisation. The unique structure of cross linked polyplasdone (sometimes referred to as crospovidone) provides superior adsorptive capacity and exceptional swelling rate. Suitable methods for preparing cross linked polyplasdone can be found in EP 1263814 & EP 1036839.

### Water-Swellable Cellulose

Ideally present in the composition in amounts of up to 0.1% possibly up to 0.2, 0.4, 0.6, 0.8. 1.0, 1.2 or 1.4% by weight of the composition. Ideally the water-swellable cellulose is provided as at least 5%, 10%, 15%, 20%, 25%, 30%, 35%, 40%, 45%, 50%, 55%, 60%, 65%, 70%, 75%, 80% or 85% by weight of the disintegrant blend. Ideally the water-swellable cellulose is provided as no more than 95%, 90%, 85%, 80%, 75%, 70%, 65%, 60%, 55%, 50%, 45%, 40%, 35%, 30%, 25%, 20%, 15% or 10% by weight of the disintegrant blend.

Suitable water-swellable cellulose materials have sufficient water-absorptivity that they can absorb at least 15, 12, 10, 8, 6, 4, 2, 1 times their own weight of water, ie. a water uptake of at least 15, 12, 10, 8, 6, 4, 2, 1 g per g of deionised water at 20° C.

A number of such materials are known, and which may be chemically modified to enhance its water uptake capacity. Sometimes such modified celluloses have ionic substituents but for this invention it is preferred that any substituents are nonionic.

For the avoidance of doubt water-swellable cellulose does not include microcrystalline cellulose commonly used in compacted compositions. Microcrystalline cellulose is used as a wicking agent to bring water into the compacted composition to aid disintegration and is not water-swellable, or at least is not water-swellable to the extent required in the present invention. Microcrystalline cellulose may be included as an additional disintegrant.

The compositions may be used in ware washing using a machine or a manual method. The compositions may also be used to soften water in other cleaning methods such as hard surfaces, for example using a hand-cloth or mop, and an open vessel, for example a bucket or bowl. Thus, the cleaning method could be a method of cleaning a hard surface, for example a window, a tiled surface, shower screen, dirty tableware and kitchenware, a sanitary article, for example a bath, shower screen, lavatory, wash basin or sink, a car or a kitchen worktop.

The invention will now be described, by way of embodiment, with reference to the following Examples.

### EXAMPLES

Hardness Test

Using a dynamometer with a test piston diameter of 8 mm and a piston speed 30 mm per minute (a machine such as the ERWEKA tablet hardness tester THB 30 may be used) the maximum hardness of the tablet just prior to breakage is recorded for 4 tablets in the same orientation and averaged.

Friability Test

Ten tablets are weighed and placed into a square plastic sample holder of approximate dimensions 110×100 mm square by 170 mm long. The sample holder is rotated horizontally along it length at 50 rpm for 1 minute. The tablets are weighed again and the amount of material loss expressed as percentage

$$\% friability index = \frac{{W}_{0} - {W}_{1}}{{W}_{0}} \times 100$$

where:
W₀=initial weight
W₁=weight of the tablets after one minute of test at 50 rpm.

The tablets were pressed at between 50 and 80 N. The hardness was measured at between 180 and 260 N, the friability was AROUND 4% and dissolution times of between 20 and 30 seconds were found.

| | 1st | 2nd | |
|---|---|---|---|
| Raw Materials % wt | region | region | Total |
| Water softening | 26.000 | 35.000 | 27.800 |
| Homopolymer | | | |
| Citrate | 60.500 | 46.000 | 57.600 |
| PEG | 4.500 | 4.000 | 4.400 |
| Polyplasdone + Cellulose | 9.000 | 9.500 | 9.100 |
| Dye | | 0.016 | 0.003 |
| Filler | | 5.484 | 1.097 |
| TOTAL | 100 | 100 | 100 |

1. A compressed water-softening composition comprising at least one water-softening active and a blend of disintegrating agents comprising,
a cross linked polyplasdone;
a water swellable cellulose and, optionally
a water soluble salt.

2. A compressed water-softening composition as claimed in claim 1 wherein the composition is substantially free of surfactant or bleach ingredients.

3. A compressed water-softening composition according to in claim 1 wherein the blend of disintegrating agents is present in an amount of up to 10% by weight of the composition.

4. A compressed water-softening composition according to claim 3 wherein the blend of disintegrating agents is present in an amount of at least 0.1% by weight of the composition.

5. A compressed water-softening composition according to claim 1 wherein the water-soluble salt has a solubility of at least 50 g/100 g of deionised water at 20° C.

6. A compressed water-softening composition according to claim 1 wherein the water-swellable cellulose has a water uptake of at least 15 g of deionised water at 20° C. per g of water-swellable cellulose.

7. A compressed water-softening composition according to claim 1 wherein the water-softening active is selected from the group: ion exchange agents, ion capture agents, and anti-nucleating agents.

8. A compressed water-softening composition according to claim 1 wherein the cross linked polyplasdone is present in an amount of up to 1.4% wt. of the said composition.

9. A compressed water-softening composition according to claim 1 wherein the cross linked polyplasdone is present in an amount of up to 95% wt. of the blend of disintegrating agents.

10. A compressed water-softening composition according to claim 1 wherein the water-swellable cellulose is present in an amount of up to 1.4% wt. of the said composition.

11. A compressed water-softening composition according to claim 1 wherein the water-swellable cellulose is present in an amount of up to 95% wt. of the blend of disintegrating agents.

12. A compressed water-softening composition according to claim 2 herein the blend of disintegrating agents is present in an amount of up to 10% by weight of the composition.

13. A compressed water-softening composition according to claim 2 wherein the blend of disintegrating agents is present in an amount of at least 0.1% by weight of the composition.

14. A compressed water-softening composition according to claim 2 wherein the water-soluble salt has a solubility of at least 50 g/100 g of deionised water at 20° C.

15. A compressed water-softening composition according to claim 2 wherein the water-swellable cellulose has a water uptake of at least 15 g of deionised water at 20° C. per g of water-swellable cellulose.

16. A compressed water-softening composition according to claim 2 wherein the water-softening active is selected from the group: ion exchange agents, ion capture agents, and anti-nucleating agents.

17. A compressed water-softening composition according to claim 2 wherein the composition comprises less than 5% by weight of a surfactant or bleach ingredients.

18. A compressed water-softening composition according to claim 17 wherein the composition comprises less than 1% by weight of a surfactant or bleach ingredients.

19. A compressed water-softening composition according to claim 18 wherein the composition comprises 0% by weight of a surfactant or bleach ingredients.
